(19) United States
(12) Patent Application Publication
(10) Pub. No.: US 2005/0094005 A1
(43) Pub. Date: May 5, 2005

(54) Apparatus and method for creating dark reference signals for dark reference pixels

(75) Inventor: Weize Xu, Rochester, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/699,758

(22) Filed: Nov. 3, 2003

(51) Int. Cl. H04N 9/64

(52) U.S. Cl. 348/243

(57) ABSTRACT

A method for outputting signals from dark reference pixels, the method includes the steps of transferring signals from dark reference pixels that are shielded from light to a plurality of storage circuit elements; and transferring signals substantially simultaneously from each of the plurality of storage circuit elements to an operational amplifier on one clock cycle which operational amplifier averages all the signals from the sample and hold circuits for providing an approximate average dark reference signal.

### FIELD OF THE INVENTION

The invention relates generally to the field of dark reference pixels for image sensors assemblies and, more particularly, to such assemblies in which each of the dark reference pixels passes its signal to an operational amplifier on one clock cycle for producing an average dark reference signal, which consequently permits calibration of the image sensor.

### BACKGROUND OF THE INVENTION

Currently, image sensors include a plurality of dark reference pixels adjacent a plurality of active image pixels for providing a reference signal for each column of pixels of the active image pixels. This reference signal is used for calibrating the signals from the active image pixels as is well known in the art.

The circuitry for processing the dark reference signals typically includes sequentially clocking each signal from the dark reference pixels to an integration circuitry. This causes a clock cycle to be needed for each dark reference pixel, which produces lengthy processing time.

Although the currently known and utilized method and apparatus for processing dark reference signals are satisfactory, they include drawbacks. One such drawback is that sequential processing of the signals is time consuming and somewhat inefficient. Another drawback is that integration circuitry is needed which enhances cost and the like.

Therefore, a need exists for a method and apparatus for efficiently processing dark reference signals in a cost effective manner.

### SUMMARY OF THE INVENTION

The present invention is directed to overcoming one or more of the problems set forth above. Briefly summarized, according to one aspect of the present invention, the invention resides in an image sensor assembly comprising (a) a plurality of active pixels that receives incident light that is converted into a charge; (b) a plurality of sample and hold circuits; (c) a plurality of dark reference pixels each of which is responsive to light and each of which is shielded from light, wherein signals from each of the dark reference pixels is transferred to one of the sample and hold circuits; and (d) an operational amplifier that receives a signal from each of the sample and hold circuits on one clock cycle, wherein the operational amplifier averages the signals from the sample and hold circuits for providing an approximate average dark reference pixel signal.

These and other aspects, objects, features and advantages of the present invention will be more clearly understood and appreciated from a review of the following detailed description of the preferred embodiments and appended claims, and by reference to the accompanying drawings.

Advantageous Effect of the Invention

The present invention has the advantage of processing all of the dark reference signals on one clock cycle and elimination of integration circuitry.

### BRIEF DESCRIPTION OF THE DRAWINGS

FIG. 1 is a schematic drawing of an image sensor assembly of the present invention;

FIG. 2 is a detailed view of a sample and hold circuit of the image sensor assembly of FIG. 1;

FIG. 3 is an exploded view of the differential operational amplifier illustrating its connections; and

FIG. 4 is a perspective view of a camera for illustrating a typical commercial embodiment for the image sensor of FIG. 1.

### DETAILED DESCRIPTION OF THE INVENTION

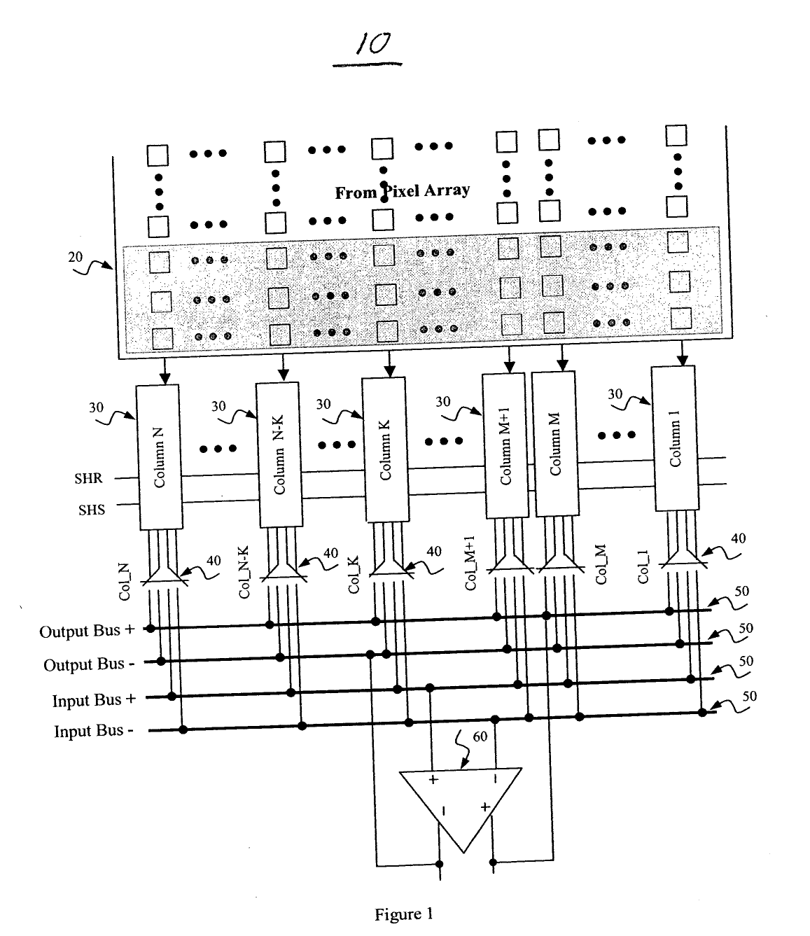

Referring to FIG. 1, a preferred embodiment includes an image sensor 10 of the present invention which includes a plurality of pixels arranged in an array of rows and columns. The upper portion includes a plurality of pixels that capture incident light used for capturing an electronic representation of the image, and the lower portion of the pixel array (typically the last three rows of pixels) includes a plurality of dark reference pixels 20 used for calibrating the image sensor 10. As is well known in the art and as used herein, dark reference pixels 20 are shielded from light by various means, all of which are well known in the art and will not be discussed herein. To read out the signals from the pixels, a plurality of sample and hold circuits 30 are connected to the image sensor 10 in which the sample and hold circuits 30 are respectively mated to a column of the pixels. Each sample and hold circuit 30 receives the pixel signals from pixels row by row. Each row of signals is received by the sample and hold circuits 30 at substantially the same time or, in other words, on one clock cycle. As is apparent to those skilled in the art, the dark reference pixels 20 will be transferred first since they are physically adjacent to the sample and hold circuits 30.

In reading out the dark reference pixels 20, a switch 40, which is attached to each sample and hold circuit 30, is closed for permitting the signal currently in the sample and hold circuit 30 to be passed to the buses 50. After the switches 40 are closed, the sample and hold circuits 30 are clocked at substantially the same time or, in other words in one clock cycle, so that the signals are passed to the buses 50 substantially simultaneously. As will be described later in detail, the sample and hold circuits 30 produce four outputs for the one input signal. The voltages on each bus 50 are then passed to a differential operational amplifier 60. The differential operational amplifier 60 then produces the average voltage (or substantially the average voltage) of the signals transmitted from the sample and hold circuits 30. This calculated average is used as the average for this row of dark reference pixels 20. This process is repeated for passing each row of dark reference pixels 20 to the differential operational amplifier 60 for creating its average for that respective row. It is instructive to note that, although sample and hold circuits and operational amplifiers are shown, any equivalent circuitry may be used for producing the same result, as those skilled in the art will readily recognize.

In reading out the pixels used for capturing the image, the pixels pass their signal to the sample and hold circuit 30 sequentially so that their actual values are passed to the operational amplifier 60, as is well known in the art.

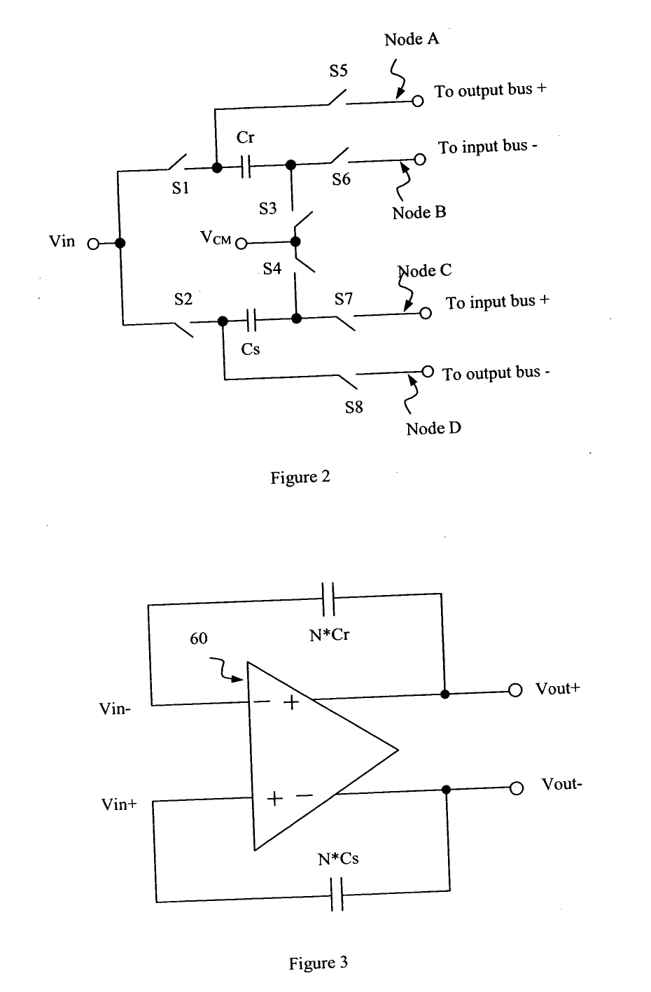

Referring to FIG. 2, there is shown a detailed view of a typical sample and hold circuit 30. The sample and hold circuit 30 receives an input voltage, as discussed hereinabove, and the switches S1 and S3 are closed for charging the first capacitor Cr, and then switches S2 and S4 are closed for charging the second capacitor Cs. Then, switches S1, S2, S3 and S4 are opened. Next, switches S5, S6, S7 and S8 are closed for passing the charge from the their respective capacitor Cr and Cs to its respective output bus.

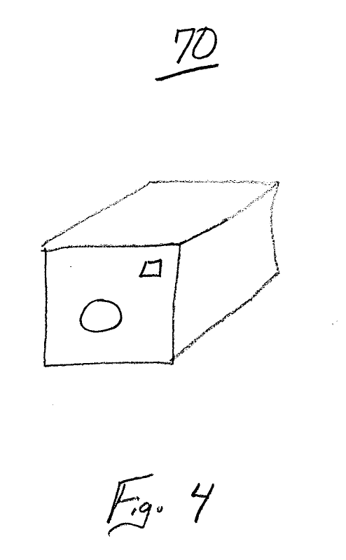

Referring to FIGS. 2 and 3, node A is connected through the bus 50 (shown in FIG. 1) to the Vout (negative), and node B is connected through the bus 50 to a Vin (positive) input of the operational amplifier 60. Node C is a connected through the bus 50 to Vin (negative) input of the operational amplifier 60, and node D is connected through a bus 50 to the Vout (positive). For clarity of understanding, the capacitors in FIG. 3 having the notation N*Cr and N*Cs represents the number of N capacitors Cr and Cs of FIG. 2 connected in parallel; where N is the actual number of sample and hold circuits.

Referring to FIG. 4, there is shown a digital camera 70 for illustrating a commercial embodiment for the image sensor 10 to which an ordinary consumer is accustomed to seeing and purchasing.

The invention has been described with reference to a preferred embodiment. However, it will be appreciated that a person of ordinary skill in the art can effect variations and modifications without departing from the scope of the invention.

### Parts List

10 image sensor
20 dark reference pixels
30 sample and hold circuits
40 switches
50 buses
60 differential operational amplifier
70 digital camera

1. A method for outputting signals from dark reference pixels, the method comprising the steps of:
(a) transferring signals from a plurality of dark reference pixels that are substantially shielded from light to a plurality of storage circuit elements; and
(b) transferring signals substantially simultaneously from each of the plurality of storage circuit elements to an operational amplifier on one clock cycle which operational amplifier substantially averages all the signals from the sample and hold circuits for providing an approximate average dark reference signal.

2. The method as in claim 1, wherein the storage circuit elements are sample and hold circuits.

3. The method as in claim 2 further comprising providing a differential operational amplifier as the operational amplifier.

4. The method as in claim 1, wherein step (a) further comprises transferring the pixel signals from the plurality of pixels to the plurality of storage elements on a row-by-row basis.

5. An image sensor assembly comprising:
(a) a plurality of active pixels that receives incident light that is converted into a charge;
(b) a plurality of storage element circuits;
(c) a plurality of dark reference pixels each of which is responsive to light and each of which is substantially shielded from light, wherein signals from each of the dark reference pixels is transferred to one of the storage element circuits; and
(d) an operational amplifier that receives a signal from each of the sample and hold circuits on one clock cycle, wherein the operational amplifier averages the signals from the sample and hold circuits for providing an approximate average dark reference pixel signal.

6. The image sensor as in claim 5, wherein the storage element circuits are sample and hold circuits.

7. The image sensor as in claim as in claim 6, wherein each of the sample and hold circuits further comprises a charge storage element mated to each signal from the dark reference pixels, wherein a signal from each charge storage element is passed to the operational amplifier.

8. The image sensor as in claim 5, wherein the operational amplifier is a differential amplifier.

9. The image sensor as in claim 5, wherein the pixel signals are transferred from the plurality of pixels to the plurality of storage elements on a row-by-row basis.

10. A camera comprising:
an image sensor comprising:
(a) a plurality of active pixels that receives incident light that is converted into a charge;
(b) a plurality of storage element circuits;
(c) a plurality of dark reference pixels each of which is responsive to light and each of which is substantially shielded from light, wherein signals from each of the dark reference pixels is transferred to one of the storage element circuits; and
(d) an operational amplifier that receives a signal from each of the sample and hold circuits on one clock cycle, wherein the operational amplifier averages the signals from the sample and hold circuits for providing an approximate average dark reference pixel signal.

11. The camera as in claim 10, wherein the storage element circuits are sample and hold circuits.

12. The camera as in claim 11, wherein each of the sample and hold circuits further comprises a charge storage element mated to each signal from the dark reference pixels, wherein a signal from each charge storage element is passed to the operational amplifier.

13. The camera as in claim 10, wherein the operational amplifier is a differential amplifier.

14. The camera as in claim 10, wherein the pixel signals are transferred from the plurality of pixels to the plurality of storage elements on a row-by-row basis.
